(19) United States
(12) Patent Application Publication
(10) Pub. No.: US 2014/0331887 A1
(43) Pub. Date: Nov. 13, 2014

(54) Derailment-Preventing And Rerailing Safety Device For A Guide Unit Having Rollers Rolling On A Guide Rail

(71) Applicant: NewTL, Emolsheim (FR)

(72) Inventor: Jean-Luc Andre, Molsheim (FR)

(21) Appl. No.: 14/359,227

(22) PCT Filed: Nov. 20, 2012
(86) PCT No.: PCT/IB2012/056560

§ 371 Date: May 19, 2014

(30) Foreign Application Priority Data
Nov. 22, 2011 (FR) 11 60665

(51) Int. Cl. B61F 9/00; B62D 1/26

(52) U.S. Cl. CPC B61F 9/00; B62D 1/265
USPC 104/246

(57) ABSTRACT

The anti-extraction safety system incorporates, on each side, one side component which does not rotate with the corresponding roller, that incorporates at least one inclined flap articulated to pivot between a lowered position wherein its lower part extends under the rail head, and a raised position in which its lower part is laterally distanced from the rail. The pivot axis of the flap is inclined upwards and is located in the rear part of the flap, above the lower part in the lowered position. This flap is subjected to a downward return force which maintains it in the lowered position, but which allows it to pivot to the raised position when an upward force greater than the return force, is applied on its lower part.

### FIELD OF THE INVENTION

The present invention concerns an anti-extraction safety system with re-engagement, for a system of guidance of a road vehicle guided by one or more rollers rolling on a guide rail, on the ground, for example.

### BACKGROUND OF THE INVENTION

Advantageously, when the guidance system accidentally disengages from the guide rail, the operation of the anti-extraction safety system according to the invention then commences a phase of automatic re-engagement around the upper part of the guide rail, subsequent to its downward force, and the subsequent opening of the holding parts for their re-engagement around the guide rail, to provide the anti-extraction safety function.

The invention is appropriate more particularly, but not exclusively, for urban public transport vehicles guided along a guide rail by means of a set of guide rollers.

To ensure their guidance, guided public transport vehicles of this type incorporate a guidance system which continuously follows a continuous guide rail, on the ground, for example, along the route of the vehicle.

This guidance system includes, for example, guide rollers inclined in a V-configuration or a vertical roller with a horizontal axis, that roll on tracks provided on the upper part of the head of the guide rail, with the guide rail incorporating a rail head with protruding sides, under each of which is a recess.

To guarantee the safety of the vehicle and its passengers, it is essential that contact be ensured between the guidance system carried by the vehicle and the guide rail, namely between the guide rollers and their rolling tracks, when the vehicle is traveling.

For this, the guide rollers are conventionally pressed against the guide rail by a resilient return force directed downwards, for example, by means of one or more spring-mounted arms, or by gravity return of the guidance head.

While such a system is sufficient under normal circumstances, there are exceptional cases where a force exceeding the downward force is exerted in the opposite direction to the guidance system. Such a force raises the guidance system above the guide rail and removes it from the guidance area. The guide rollers lift away from the guide rail and, when the vehicle moves forward, derailment can occur.

Such a situation can occur, for example, when an object of some kind is located on the guide rail or in the grooves on the side of the rail head, if such grooves exist.

In effect, due to exposure to weather and the ambient environment of the guide track, it commonly occurs that the guide rail and/or its lateral grooves become locally encumbered or obstructed by matter of all kinds, vegetation, ice, snow, stones or other foreign objects deposited by accident, vandalism or whatever cause, thereafter constituting an obstacle to the passage of the guide roller(s), giving rise to their lifting and disengagement from the rail.

The lifting of the guide rollers and the ensuing detachment of the guidance system from the guidance area of the rail constitute an unacceptable hazard giving rise to major problems, notably derailment of the guidance system and, subsequently, the vehicle's exit from its trajectory.

To prevent lifting and detachment of the guidance system of these vehicles, there are, in prior art, guide rollers equipped with flanges covering the rollers on their outer face, and terminating in a peripheral extension.

These flanges are conventionally produced integral with or secured to the guide rollers, and rotate at the same time as the aforementioned guide rollers.

In the operational position of the guide rollers, each peripheral extension of the flanges engages in the recess beneath the top of the guide rail, under the corresponding protruding side of the rail head, and opposes withdrawal of the guidance system in the event of a lifting force on the rollers.

However, because these flanges rotate with the guide rollers when the vehicle moves forward, their dynamic retention from detachment is relatively weak, due to a meshing phenomenon that occurs when the flange comes to bear against the side of the rail under the effect of a lateral force. The invention eliminates this rotation of the flange and replaces it with a fixed bearing force pressing against the rim of the track in the event of lateral forces.

Furthermore, the system according to prior art provides no means of re-engagement in the event of disengagement of the guidance system from the guide rail.

Also known is an anti-extraction safety system for a guidance system with inclined rollers, described in patent FR 2,910,423 filed in the name of LOHR INDUSTRIE.

In this device, each roller has a fairing part fixed in rotation, of which the base has a lower extension that extends, in the usage position, under the corresponding protruding side of the guide rail, so as to oppose any extraction force acting on of the guidance system.

Unlike the flanges in prior art, the fairing parts do not rotate with the guide rollers, and are fixed in rotation. The force necessary to successfully cause the extraction of the guidance system according to the invention is therefore much greater, because the meshing phenomenon is eliminated.

However, while this anti-extraction system is more effective and advantageous than the preceding system with flanges, it still has certain disadvantages.

This is because, in exceptional circumstances, this anti-extraction system can detach from the guide rail.

Such a situation can occur, for example, when the head of the guide rail is damaged locally, or when the guide rail is worn, defective or intermittently missing on the vehicle's route.

The fixed fairing parts of the anti-extraction system, which are subject to very strong forces and stresses at their lower extension, in the event of strong vertical force, can also be worn, distorted or twisted. In this case, when an exceptional obstacle such as a stone, debris or ice, is encountered under the wheels of the vehicle or in the gaps beside the guide rail, the vertical force exerted on the guidance system can then cause it to disengage from the guide rail.

In this situation, the anti-extraction system of prior art has no means of automatic re-engagement around the guide rail. Worse still, because of the presence of the fixed lower extensions of the fairing parts, any re-engagement of the guidance system around the guide rail is opposed. The guidance system can then no longer fulfill its function. As a consequence of the vehicle no longer being guided, there is a major risk of an accident.

### SUMMARY OF THE INVENTION

The aim of the invention is to provide an anti-extraction safety system with fixed fairing parts not having the drawbacks of prior art.

The anti-extraction safety system according to the invention advantageously incorporates a means for automatic re-engagement of the guidance system around the guide rail in the event of an unintended disengagement of the system.

The means of re-engagement may be commanded by an actuator. This variant is useful if, for example, the vehicle is a bi-directional guided road vehicle. One then commands the opening of the flaps so as to deliberately disengage from the rail.

To resolve this technical problem, the invention provides an anti-extraction safety system for a guidance system for a road vehicle with one or more rollers, designed to roll along the upper part of a guide rail head with protruding sides, with each one connecting with the body of the rail via a recess.

This guidance system is connected to the vehicle via a flexing connection that maintains the guidance head against the head of the guide rail.

The anti-extraction safety system has, on each side, a side component that does not rotate with the corresponding roller, and of which the base is designed to be located, in use, under the corresponding protruding side of the guide rail, so as to counteract a force that would cause extraction of the guidance system.

According to the invention, each of these side components incorporates at least one flap inclined downwardly towards the guide rail, or a flap in an inclined trajectory. This inclination is very important. It can be imposed by the inclination of the pivot axis of the flap. This flap is articulated to pivot around a pivot axis, between a lowered safety position in which its lower part extends, in use, under the corresponding protruding edge of the guide rail, so as to oppose the extraction of the guidance system, and a raised re-engagement position in which its lower part is, in use, laterally distanced from the corresponding protruding side of the guide rail, thus allowing its vertical passage in relation to the guide rail, and allowing re-engagement of the guidance system.

For this, the pivot axis of the flap is inclined upwardly towards the guide rail, so as to endow the said flap with an engaging trajectory towards the body of the guide rail when the flap descends. It is preferably located at the rear part of the flap, relative to the direction of travel of the vehicle

When the flap is in the lowered safety position, the pivot axis is located above the lower part of the flap, which extends under the protruding edge of the guide rail.

Thus, there are two characteristic positions of the flap: a lowered safety position which is the normal running position in which the lower parts of the flaps clasp the head of the guide rail, and a raised re-engagement position in which the lower parts of the flaps are sufficiently separated to allow passage for the rail head.

According to the invention, this inclined flap—of which there might be only one—is subjected to a downward return force that maintains it in the lowered safety position, but that allows the pivoting of the flap towards the raised re-engagement position when an upward re-engagement force that exceeds the downward return force is exerted on the bottom part of the at least one flap.

This return force, which constrains the flap to remain in the closed safety position, can be a simple gravity-driven return exerted by the flap's own weight, endowed by design, by virtue of the shape of the flap and the positioning of the pivot pin.

There can also be a resilient return force that accentuates this effect. For example, each of the side components may also incorporate at least one resilient means of thrust, preferably of spring type, which exerts a downward return force on the at least one inclined flap.

This return force is however lesser than the force of pressure towards the guide rail exerted by the connection joining the guidance system to the vehicle, or exerted by the own weight of the guidance head.

The invention thus provides an automatic means of re-engagement of the guidance system around the guide rail, which is activated automatically as soon as the anti-extraction safety system passes above the rail.

According to a preferred implementation of the invention, the base of the inclined flaps may be shaped in a beak form that ejects objects present on the guide track, that might hinder guidance of the vehicle.

Advantageously, as the base of these flaps is below their pivot axis, and because these axes are located to the rear of the flaps, in the direction of travel of the vehicle, it means that when one of the flaps encounters a foreign object stuck in the groove of the rail, the impact exerts—at the base of the said flap—a horizontal force directed towards the rear, that is applied below the axis of articulation of the flap. This force thus tends to pivot the flap in question downwards—and towards its lowered safety position, therefore—which prevents the extraction of the guidance head. Thus, encountering an object present in the groove of the rail tends to close the anti-extraction safety system according to the invention, which is safe.

According to another advantage of the invention, thanks to the pivoting nature of the inclined flaps, the anti-extraction safety system is very easily dismountable, or is at least retractable, which provides very easy to access the parts of the guidance system located behind, notably including the inclined rollers, of which the tires must be replaced regularly.

Maintenance operations are thus much quicker and easier than with anti-extraction systems of prior art.

### BRIEF DESCRIPTION OF THE DRAWINGS

Other characteristics and advantages of the invention will come to the fore on reading the detailed description that follows, the which description refers to the accompanying drawings, in which:

FIG. 1 is a general perspective view of a set of inclined guide rollers equipped with an anti-extraction safety system according to the invention;

FIG. 2 is a general front view of a guidance system with inclined rollers, equipped with an anti-extraction safety system according to the invention, in the lowered safety position and engaged with a guide rail;

FIG. 3 is a side view of a flap and a roller, both of which are inclined, as per a basic variant of the anti-extraction safety system according to the invention, in the lowered safety position, mounted on a guidance system;

FIG. 4 is a top view of the device in FIG. 3;

FIG. 5 is a cross-section of the device in FIG. 3, along a plane V-V passing through the axis of rotation of the inclined rollers;

FIG. 6 is a cross-section of the device in FIG. 3, along a plane VI-VI through the axis of pivoting of the inclined flaps;

FIG. 7 is a side view of an inclined flap of the system shown in FIG. 3, illustrated alone;

FIG. 8 is a side view of an inclined roller with an inclined flap in the lowered position, ready for maintenance;

FIGS. 9 and 10 are respectively a corresponding front and side view of the device in FIG. 3, in the usage position, namely in engagement with a guide rail;

FIGS. 11 to 20 are paired views, with a corresponding front and lateral illustration, showing the successive steps of a sequence of automatic re-engagement of the device in FIG. 3;

FIG. 21 is a elevational side view of a second variant of the anti-extraction safety system according to the invention, in the lowered safety position, mounted on a guidance system;

FIG. 22 is a view in the plane of the flap, from the rear face of the two inclined flaps, of one of the side components of the device in FIG. 21, illustrated alone;

FIGS. 23 and 24 are respectively a front and side of the device in FIG. 21, in the usage position, namely in engagement with a guide rail;

FIGS. 25 to 32 are paired views, showing corresponding front and lateral illustrations, showing the successive steps of a sequence of automatic re-engagement of the device in FIG. 21;

FIGS. 33 and 34 are cross-sections of the device in FIG. 21, illustrated in accordance with the plane of cross-section respectively XXXIII-XXXIII of FIG. 29 and XXXIV-XXXIV of FIG. 31, which passes through the plane of the inclined flaps, which are respectively in the raised re-engagement position and in the lowered safety position.

### DETAILED DESCRIPTION OF THE INVENTION

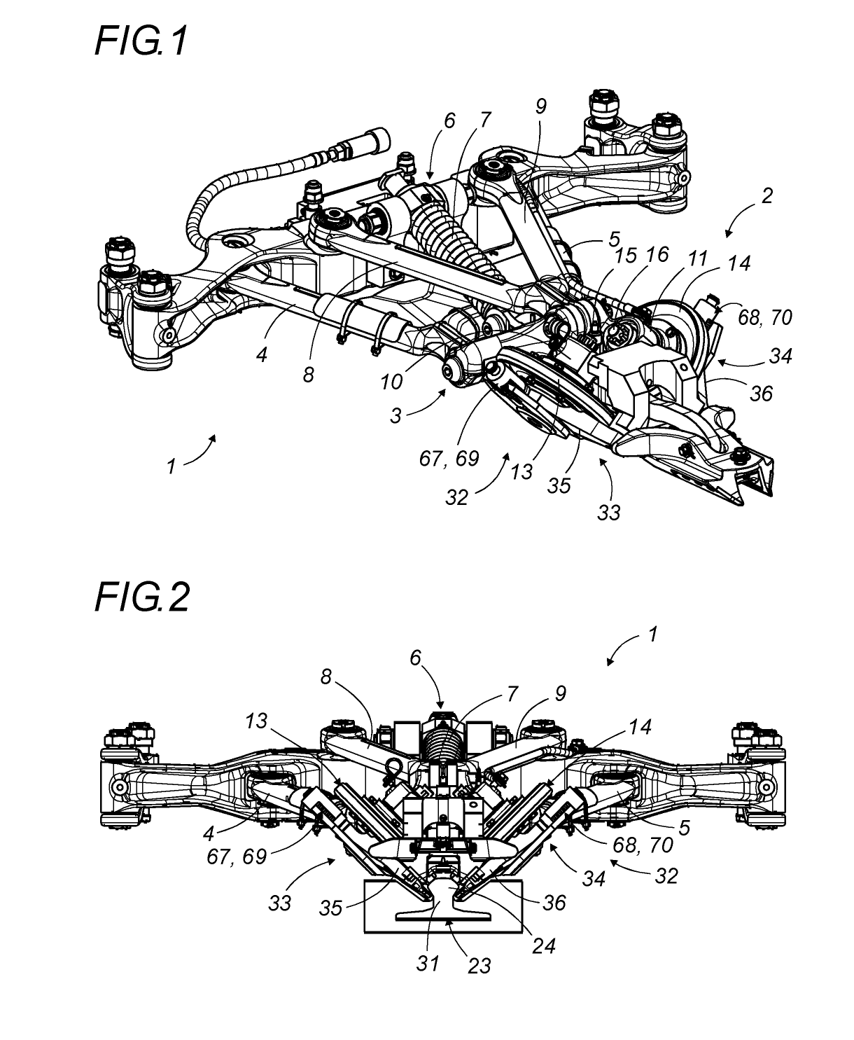

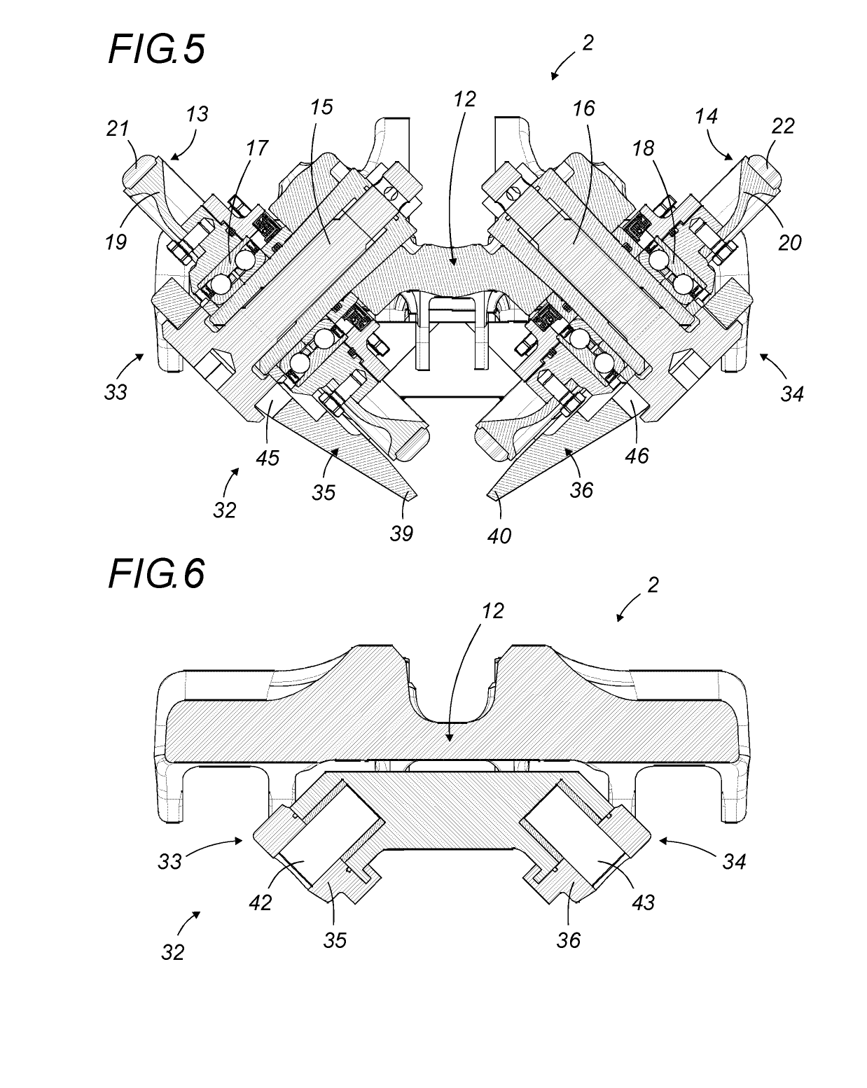

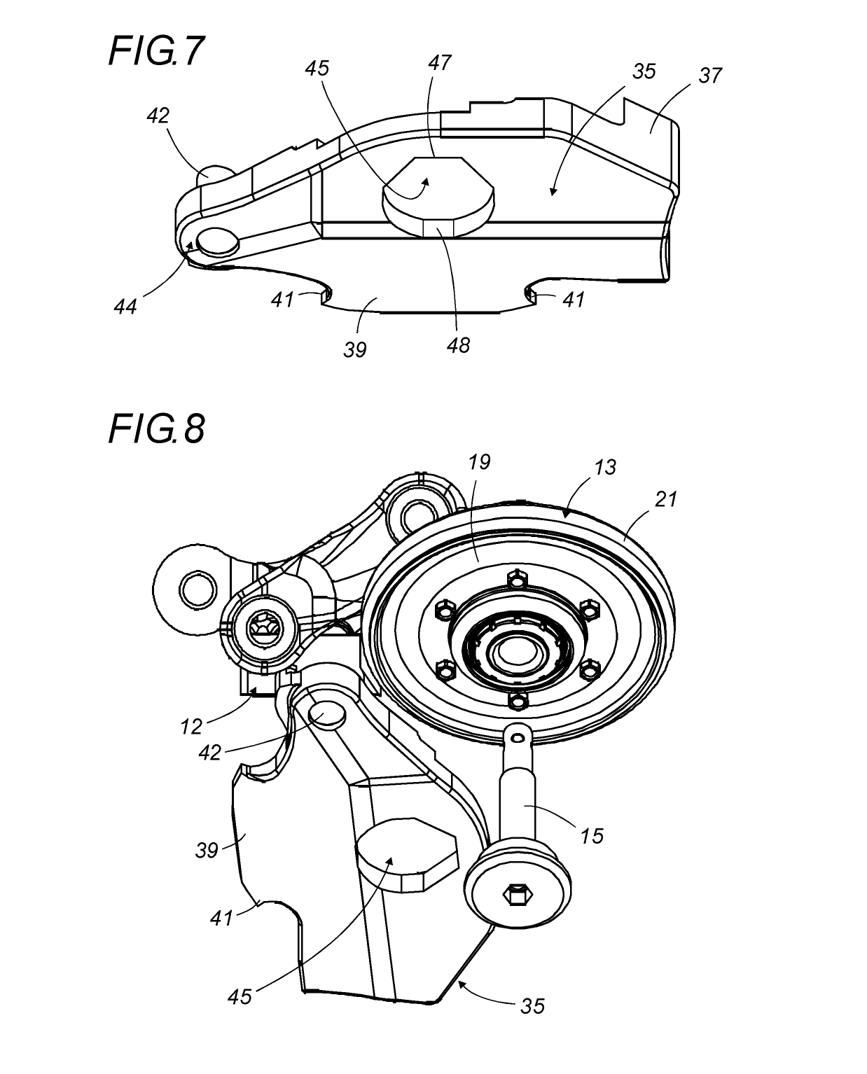

The anti-extraction safety system according to the invention herein will now be described in detail, with reference to FIGS. 1 to 34. Equivalent items in the various figures are assigned the same reference numbers.

Further on in this description, the concepts of top and bottom, lower and upper, etc., are defined in accordance with the orientation adopted in the various Figures.

Similarly, front and rear are defined in accordance with the direction of travel of the vehicle.

The anti-extraction safety system according to the invention can be implemented, for example, for a guidance system (1) as shown in FIG. 1.

There is a guidance head (2) pivotally mounted on a pivoting mounting (3), which itself is mounted on the vehicle by means of two pivoting arms (4) and (5), and a connection (6) with a downward resilient force, for example, by means of a spring (7), or a piston, or by means of simple gravity-driven return. This mobile assembly bears the guidance head (2), having the form of a deformable parallelogram, with multiple pivoting articulations, and with a return tendency endowed by two articulated arms (8) and (9).

Of course, this mechanical mounting and articulation assembly can be replaced by any equivalent system, or even a separate but functionally equivalent system, without detracting from the inventive nature of the invention herein.

The illustrated guidance head (2) consists of two roller-bearing assemblies (10) and (11) fitted on a mounting (12), with each one carrying a rotating inclined roller, respectively (13) and (14), via a shaft (15, 16), on each of which is mounted a bearing such as (17) or (18), preferably tapered.

The rollers are preferably of lightened rim type, (19) and (20), with tires (21) and (22) made of composite material.

This assembly constitutes the system of guidance along a guide rail (23), on the ground, for example, of the type, as shown in the Figures, with a head (24) having two protruding sides, (25) and (26), each having an inclined rolling track (27, 28) at the top, for the rollers (13) and (14) of the guidance system, and a recess (29, 30) at the bottom, in the area where each protruding side (25, 26) is joined to the body (31) of the rail.

The guidance system (1) is shown equipped with an anti-extraction safety system (32) with automatic or commanded re-engagement according to the invention.

On each side, there is a side component (33, 34) that is mounted on the guidance head (2), but that does not rotate with the corresponding inclined roller (13, 14).

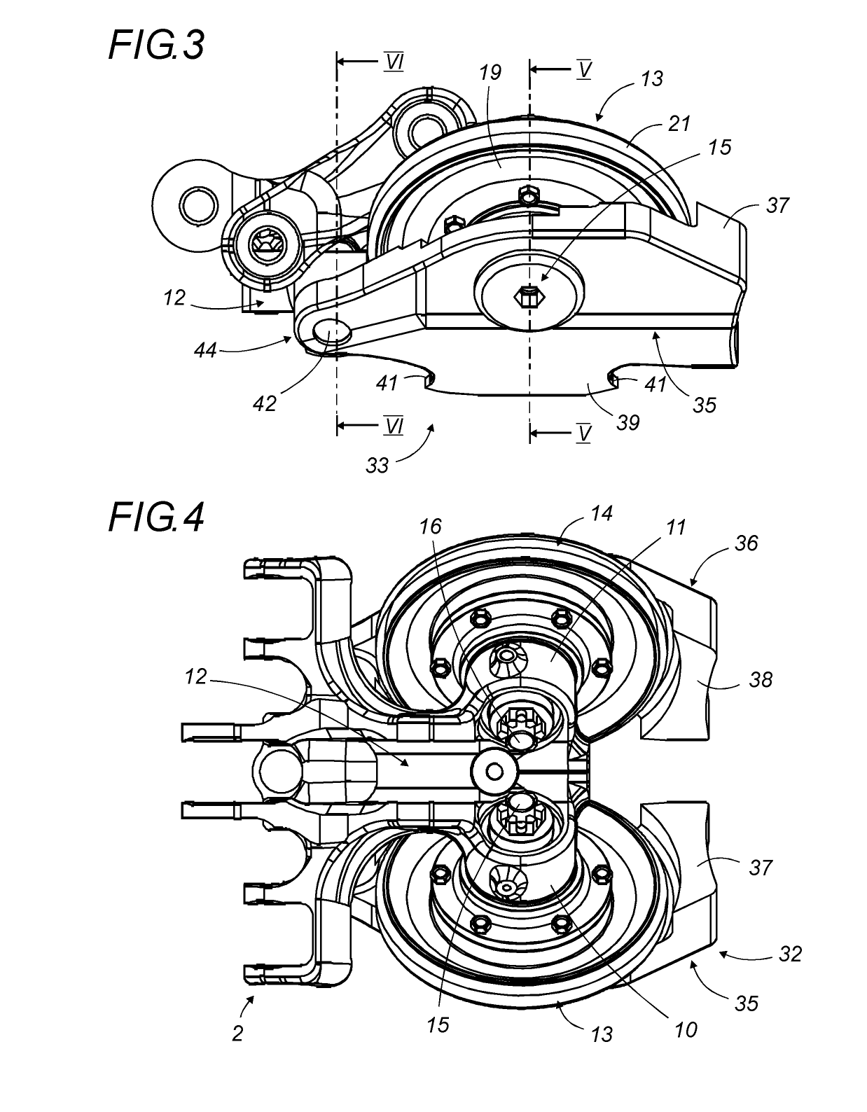

In one basic variant of the invention shown in FIGS. 3 to 20, each of these side components (33) or (34), includes an inclined flap, respectively (36) or (35).

In one basic version, only one of the two flaps is articulated; the other can remain fixed.

These flaps (35, 36) are positioned next to the lower part of the corresponding inclined guidance roller (13, 14). They are downwardly inclined towards each other, namely towards the guide rail (23).

Although this system works for a single vertical roller, if there are two guide rollers inclined in a V-configuration, the flaps preferably have an inclination that approximately corresponds to that of the corresponding inclined roller (13, 14), but which can advantageously be slightly greater, in order to better withstand the frictions that occur when the system has to counteract a force of extraction of the guidance system. What is important is, of course, the inclination of the axis of articulation of the flap.

These flaps (35, 36) are preferably substantially planar and of any suitable shape—for example, essentially of rectangular, triangular or hexagonal overall shape with a front corner that is truncated, as per the illustration, or else not truncated.

Obviously, the flaps (35, 36) may incorporate parts of greater thickness in the areas that are most heavily stressed when in use.

The inclined flaps (35, 36) preferably have an enveloping form that covers the lower part of the guide rollers (13, 14). In addition to their anti-extraction function, they are thus able to protect the rollers, notably from projections and the ejection of objects while rolling.

The front part of these flaps may thus, for example, be extended by an enveloping bend (37, 38) in the manner of a fairing. In the case of a downward return of the flaps that is only gravity-driven, this form augments the downward return force, namely return of the flaps to the lowered safety position, which is the closed position of the system.

However, the inclined rollers (13, 14) preferably remain unenclosed at the top, to allow natural ventilation and visual inspection of wearing of the tires (21, 22).

The lower part, respectively (39) and (40), of each of these flaps (35, 36) is intended to serve as an anti-extraction claw, by engaging underneath the corresponding protruding side (25) or (26 of the guide rail (23), so as to oppose any extraction force acting on the guidance system (1).

It can also fulfill an additional function of guard-iron against stones or debris, by allowing the lifting and ejection of any objects present in the grooves of the guide rail that could hinder guidance of the vehicle. For this, the front end of the lower part (39, 40) of the inclined flaps (35) and (36), or else the front and rear ends of these lower parts (39, 40), in the case of a symmetrical variant, can advantageously be shaped as an ejection beak, such as (41).

Each of the inclined flaps (35, 36) is pivotally articulated by means of a pivot pin (42, 43), preferably girded at the rear of the flap, that engages pivotally in the mounting (12) for the roller mounting assemblies (10) and (11).

This pivot pin (42, 43) is inclined upwardly and located at the rear of the flap, relative to the direction of travel of the vehicle.

The inclined flaps (35, 36) can thus pivot in their respective plane around this inclined pivot axis (42, 43).

As the flaps (35) and (36) are vertically downwardly inclined towards each other, and as their axis of pivoting (42, 43) is also inclined, it means that when they pivot in their respective plane, the distance between the lower parts (39) and (40) of the flaps (35, 36), is reduced when they pivot downwards, and increased when they pivot upwards.

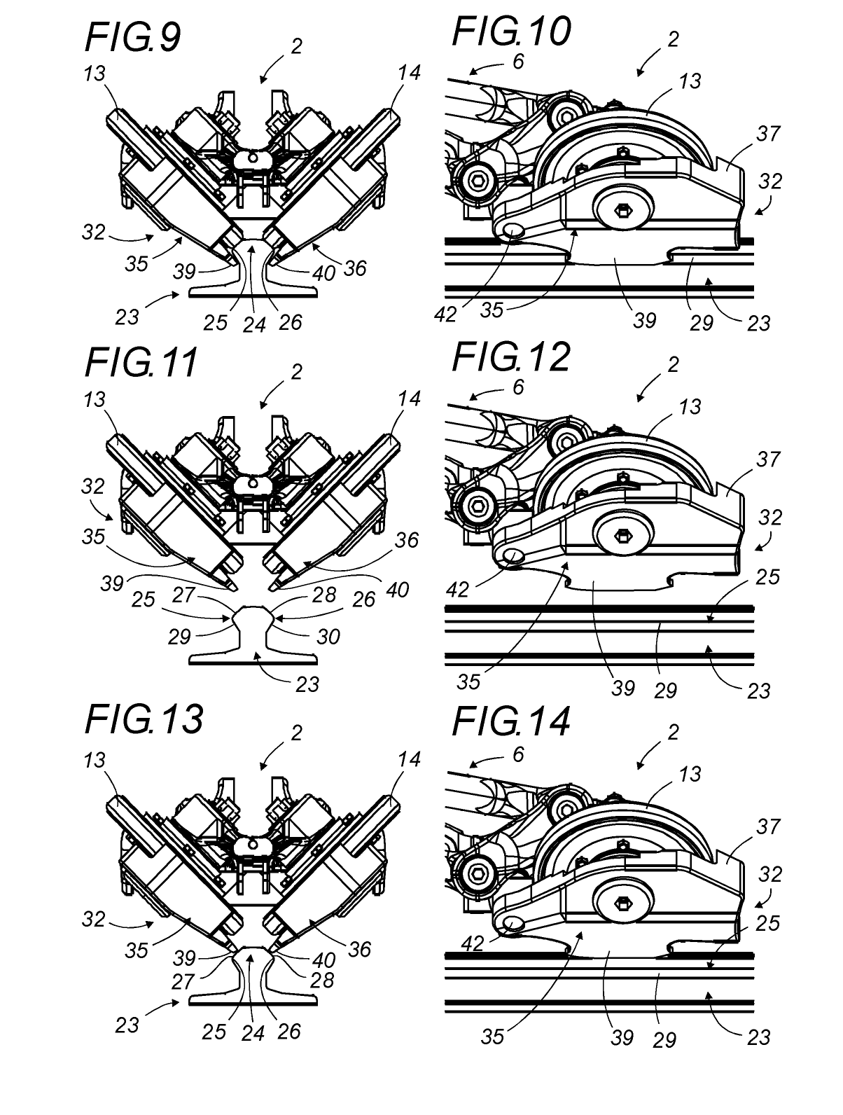

Through this pivoting, the inclined flaps (35) and (36) can thus reach two limit positions: a lowered safety position illustrated in FIGS. 9 and 10, and a raised re-engagement position shown in FIGS. 17 and 18.

In the lowered safety position, the lower parts, 39 and 40, of the inclined flaps (35, 36) are moved towards each other. In use, they extend under the corresponding protruding side (24, 26) of the guide rail (23), and extend as far as the recess (29, 30) of the guide rail (23).

In this position, the inclined flaps (35, 36) oppose the extraction of the guidance system (1), and endow the desired anti-extraction and ant-detachment safety through their combined action.

In the raised re-engagement position, the lower parts (39) and (40) of the inclined flaps (35, 36) are distanced from each other. In use, they are laterally distanced from the protruding sides (25, 26) of the guide rail (23). The head (24) of the guide rail (23) is thus able to pass through, which allows re-engagement of the guidance system (1) around the guide rail (23), as will be explained subsequently.

The pivot axis (42, 43) is preferably located in the rear part of the inclined flaps (35) and (36), in the direction of forward travel of the vehicle and, for example, at the rear corner (44) of these flaps (35, 36) when they are of generally triangular form or approximately hexagonal form, as in the illustrated form of implementation.

These axes are inclined. This orientation is important if one wants to obtain the engaging/disengaging trajectory of the flap.

Thus, in the event of an impact against an obstacle or debris, the inclined flaps (35, 36) tend to pivot downwards, which has the effect of bringing the lower parts (39) and (40) of the inclined flaps (35, 36), and thus augmenting the anchoring of the guidance head (2) applied by the anti-extraction safety system (32).

The inclined flaps (35, 36) preferably each have a cutout, respectively (45) and (46), of rounded or polygonal shape, for example, located at the position of the shaft (15, 16) of the corresponding inclined roller (13) or (14).

The shafts (15, 16) of the inclined guide rollers (13, 14) can thus advantageously each pass through one of these cutouts (45, 46) and extend beyond the corresponding inclined flap (35, 36).

These shafts (15) and (16) are fixed in rotation and thus serve as a travel limiter for the pivoting of the inclined flaps (35, 36), in both the characteristic extreme positions of the system. In effect, they act both as lower travel limiters in the lowered safety position of the inclined flaps (35, 36) by the bearing of the upper rim (47) of the cutouts, (45, 46) against the upper part of the shafts (15, 16), and as upper travel limiters in the raised re-engagement position of the inclined flaps (35, 36), by bearing of the bottom rim (48) of the cutouts (45, 46) against the lower part of the shafts (15, 16).

They also serve advantageously as a bearing point to limit the separation of the flaps in the event of lateral forces. This is because, when a lateral force is exerted on the bottom part of a flap, it tends to flex. The shaft (15, 16) of the corresponding roller, with its shoulder, retains it, in addition to the recessing endowed by the pivoting articulation of the flap.

Obviously, these cutouts (45) and (46) must be of appropriate shape and dimensions, which is dependent on those of the shafts (15, 16), so that the inclined flaps (35, 36) can achieve the travel for the proper operation of the anti-extraction safety system (32) according to the invention. Also, there must be a small clearance between the shoulder of the shaft (15, 16) of the roller and the corresponding inclined flap (35, 36), so as not to impede its travel.

Obviously, the invention is not limited to this type of travel limiter. A professional could devise many other means of travel limitation that are fixed in rotation, that would enable the establishment of two characteristic limiting positions of the system. For example, one could devise fixed travel limiters that lift from the mounting (12) of the roller mounting assemblies (10, 11).

One could also devise a sliding device, for example, at the front of the flap, in opposition to its axis of articulation, to increase its recessing during transversal flexing.

As stated in the introduction, the anti-extraction safety system (32) is easily dismountable or retractable. As can be seen in FIG. 8, you can simply remove the shaft (15), and fully pivot the inclined flap (35) downwards, which is then no longer retained in travel limitation, so as to gain direct access to the inclined guide roller (13).

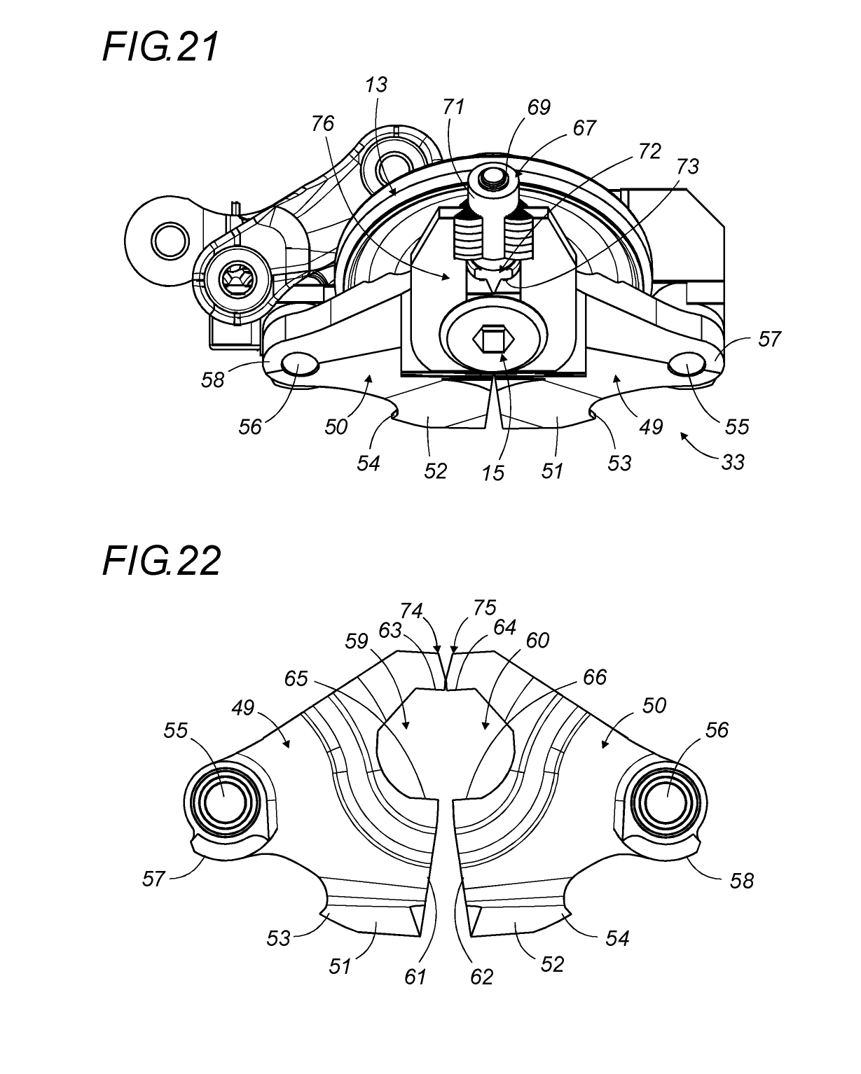

In a second implementation of the invention shown in FIGS. 21 to 34, each side component (33) or (34) incorporates not one but two inclined flaps: a front flap (49) and a rear flap (50).

To simplify the description, only the first side component (33) of the anti-extraction safety system (32) is described below. It is understood that the second side component (34) is composed of similar parts fulfilling identical functions.

The flaps (49, 50) are of generally triangular overall shape, and are positioned in extension of each other, in opposing directions, so as to have the approximate shape of a single flap (35) or (36) as per the basic variant.

The lower part, respectively (51) and (52), of each of these front (49) and rear (50) flap acts as an anti-extraction claw by engaging under the corresponding protruding side (24) or (26) of the guide rail (23), and by thus opposing any extraction force exerted on the guidance head (2).

In the illustrated triangular variant of the flaps (49, 50), the lower part (51, 52) corresponds more specifically to the area of the rear lower corner of the front flap (49) and the area of the lower front corner of the rear flap (50).

To act as a guard-iron, the front end of the bottom part (51) of the front flap (49) and/or the rear end of the bottom part (52) of the rear flap (50) can also be shaped as an ejection beak (53, 54).

Each of these front (49) and rear (50) flaps is individually and independently pivotally articulated by means of an inclined pivot axis, respectively (55) and (56), that extends to the back of the flap and engages pivotally in the mounting (12).

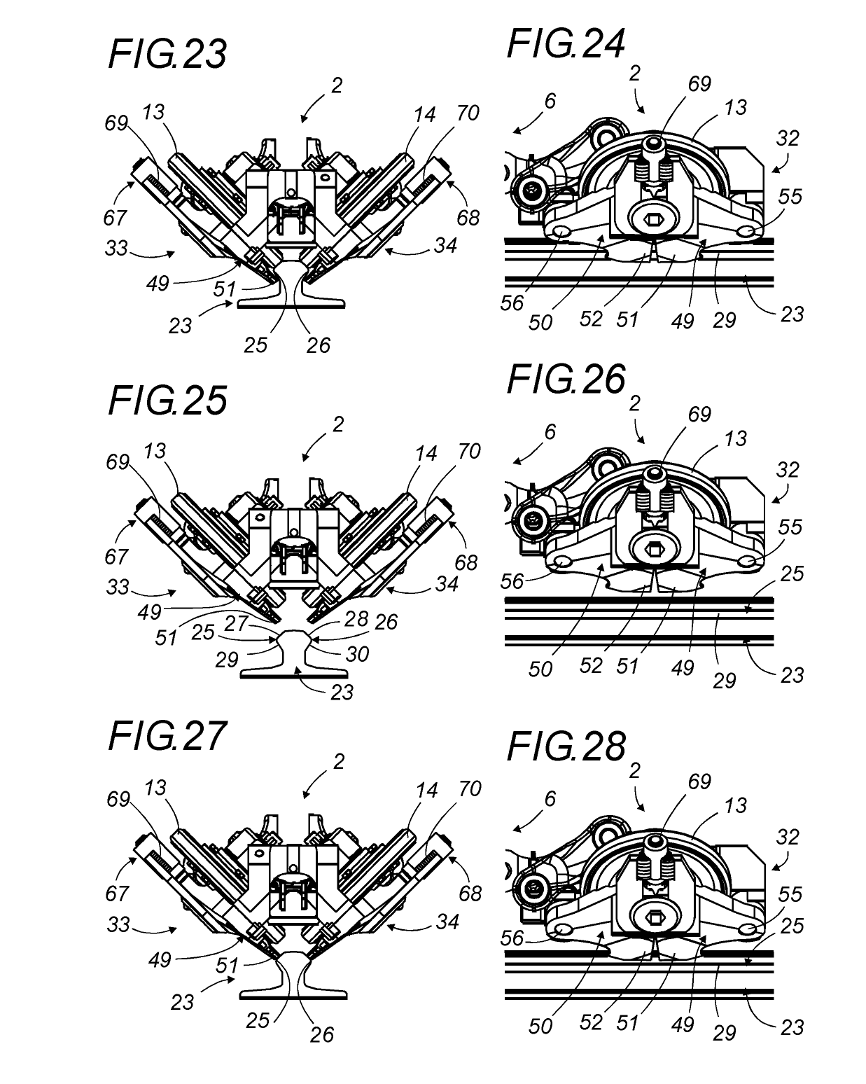

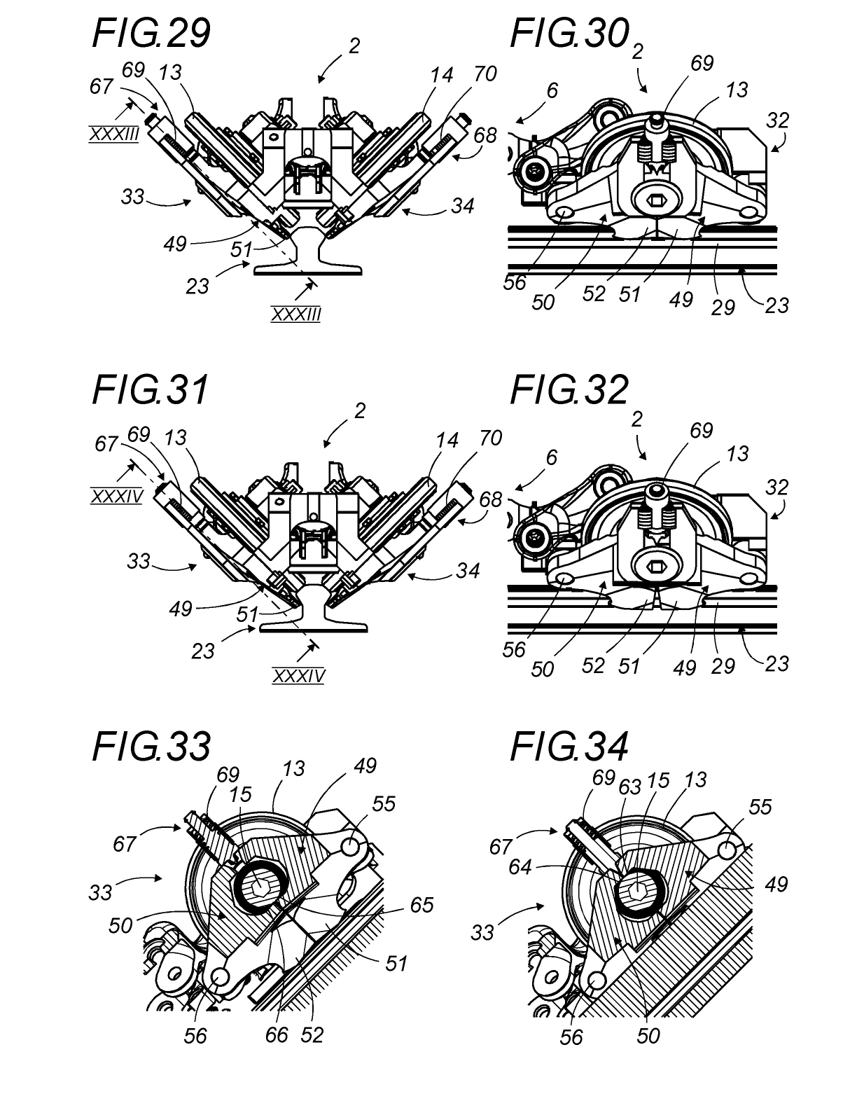

These inclined front (49) and rear (50) flaps can thus pivot in their respective plane around these inclined pivot axes (55, 56), and thus attain two limiting positions: a lowered safety position, illustrated in FIGS. 23 and 24, in which their bottom parts (51, 52) extend under the corresponding protruding side (25) of the guide rail (23), and a raised re-engagement position shown in FIGS. 29 and 30, in which their lower parts (51, 52) are distanced laterally from the corresponding protruding side (25) of the guide rail (23), and allow the re-engagement of the guidance system (1).

In the preferential implementation illustrated, the pivot axis (55) of the front flap (49) is located in the front part thereof, preferably at the front corner (57) of the front flap (49), and the pivot axis (56) of the rear flap (50) is located in the rear part of the rear flap (50), preferably at the rear corner (58) thereof.

Thus, if the first flap, in the direction of travel of the vehicle, namely the front flap (49) has a tendency to pivot upwards during a frontal impact against an obstacle or debris, the second flap, namely the rear flap (50), has a contrary tendency to pivot downwardly, which has the effect of drawing towards it the lower part (52) of its counterpart, belonging to the second side component (34), and thus augmenting the system's resistance to detachment.

As in the basic implementation described above, the front (49) and rear (50) flaps each have a cutout (59, 60), of substantially semi-circular shape, for example, which opens—in one case—on the rear edge (61) of the front flap (49) and—in the other case—on the front edge (62) of the rear flap (50).

When the flaps (49, 50) are in the usage position, these cutouts (59, 60) extend opposite each other, and are in correspondence with each other, thereby forming an opening through which the shaft (15) or (16) of the corresponding inclined guide roller (13, 14) can pass.

This shaft (15) or (16) can then act as a travel limiter for the pivoting of the two inclined flaps (49) and (50) to their two limiting positions, as illustrated in FIGS. 33 and 34.

In effect, in the lowered safety position (FIG. 34), the front (49) and rear (50) inclined flaps bear against the upper rim (63, 64) of their cutout (59, 60), against the upper part of the shaft (15); whereas in the raised re-engagement position (FIG. 33), they bear against the lower rim (65, 66) of their cutout (59, 60), against the bottom part of the shaft (15).

Again, this variant of the anti-extraction safety system (32) is easily dismountable. As before, one simply has to remove the shafts (15) and (16) to release the front (49) and rear (50) flaps of each side component (33, 34), and then downwardly pivot these front (49) and rear (50) flaps to gain direct access to the inclined rollers (13) and (14).

According to the invention, the inclined flaps (35, 36, 49, 50) are subject to a downward return force that maintains them in the lowered safety position.

This return force can be a simple gravity-driven return caused by the own weight of the flap. This is the case, for example, in the basic implementation shown in FIGS. 3 to 20.

There can also be an additional resilient return force. For this, each side component (33, 34) can also include a resilient thrust system, respectively (67) and (68), which exerts this downward return force on the at least one inclined flap.

Such a resilient thrust system (67, 68) is clearly illustrated in FIGS. 21 to 34 showing the second form of implementation of the invention.

In the example shown, there is a thrust spring (69, 70) which is fitted on a mounting such as (71) fitted at the end of the shaft (15, 16) of the corresponding inclined guide roller (13, 14).

The thrust springs (69, 70) each bear—for example, by means of a fully-depressed (73) piston (72) (preferably flat or with triangular rod)—against the upper part of the front (49) and rear (50) inclined flaps of the corresponding side component (33, 34), in order to constrain them downwards and thereby maintain them in the lowered safety position.

In the variant illustrated with two triangular flaps, the springs (69, 70) bear more specifically both on the area of the upper rear corner (74) of the front flap (49) and the area of the front upper corner (75) of the rear flap (50) of each side component (33, 34). One single spring, (69) or (70), can thus be provided for each side component (33, 34), with this single spring bearing simultaneously against the two flaps of this side component (33, 34).

However, it is perfectly possible to use a single spring for each of the front (49) and rear (50) flaps, namely two springs per side component (33, 34).

These compression springs, (69) and (70) are preferably positioned with the same inclination as the corresponding inclined flaps (49, 50), so as to exert downward pressure on it or them, with the direction corresponding to the general plane of the track(s).

According to a preferred manner of implementation of the invention, the mounting (71) of the thrust spring (69, 70) is prolonged by a side wall such as (76), that extends on the side of the system, beyond the corresponding inclined flap(s). This side wall (76) advantageously acts as a bearing wall—preferably flat—for the side face of the upper part of the inclined flap(s)—more specifically for the side face of the upper rear corner (74) of the front flap (49) and the upper front corner (75) of the rear flap (50) of the variant illustrated with two triangular flaps. This pressure advantageously improves the torsional resistance of the inclined flap(s) which, moreover, are only maintained by their pivot axis (42, 43, 55, 56).

All these inclined flaps, (35, 36) or (49, 50), which are subject to a downward return force, either through simple gravity or via a resilient thrust system (67, 68), constitute—in combination with the force of pressure towards the guide rail exerted by the resilient-force connection (6) joining the guidance system (1) to the vehicle, or by the own weight of the guidance head—a means of automatic re-engagement of the guidance system (1) on and around the guide rail (23). This means of re-engagement activates automatically when the anti-extraction device (32) departs from its engagement with the guide rail (23) and passes above it.

For this means of automatic re-engagement to work, the flaps and, where appropriate, their means of resilient thrust (67, 68) must be sized so that the sum of their vertical downward return component remains weaker than force of pressure towards the guide rail exerted by the resilient-force connection (6) joining the guidance system (1) to the vehicle, or by the own weight of the guidance head.

The operation of the anti-extraction safety system with automatic re-engagement (32), according to the invention, results from the means described above, and will now be explained with reference to FIGS. 9 to 20, in the case of the basic variant, and FIGS. 23 to 34, in the case of the second form of implementation.

In FIGS. 9, 10 and 23, 24, the device has been illustrated in a normal usage situation. This situation corresponds to a satisfactory guidance of the vehicle, with the guidance head (2) of the guidance system (1) being engaged with the guide rail (23) on the ground, via its two inclined rollers (13) and (14), which roll on the inclined rolling tracks, (27) and (28), of the head (24) of the guide rail (23).

In this situation, the inclined flaps (35, 36) or (49, 50) of the side components (33, 34) are in the lowered safety position, and their lower part, (39, 40) or (51, 52), extends under the protruding sides (25, 26) of the guide rail (23).

The distance existing between the lower parts (39) and (40), or between the lower parts (51, 52) and their counterparts on the other side component, is insufficient for the head (24) of the guide rail (23) to be able to traverse it. Thus, the guidance head (2) cannot disengage from the guide rail (23), and its two inclined rollers (13) and (14) are maintained in rolling contact with the inclined rolling tracks (27, 28) of the head (24) of the guide rail (23).

The inclined flaps (35, 36) or (49, 50) are maintained constantly in the lowered safety position, whether—in the first case—by their own weight, which impels them and causes them to tip downwards, or—in the second case—by the resilient thrust system (67, 68), which bears continually on the inclined flaps (49, 50), and pushes them downwards.

In this position, the inclined flaps (35, 36) or (49, 50) of the two side components (33, 34) oppose the extraction of the guidance system (1) and provide, by their joint action, the desired anti-extraction safety.

When, exceptionally, the guidance system disengages from the guide rail, the means of re-engagement of the anti-extraction safety system (32) of the invention is activated automatically or on command, such as illustrated in FIGS. 11 to 20, in the case of the basic variant, and FIGS. 24 to 34, in the case of the second variant.

In the event of disengagement, the guidance head (2) is located above the rail head (24), as shown in FIGS. 11, 12 and 25, 26. The weight of the inclined flaps (35, 36) and/or the pressure of the thrust springs (69, 70) acts on the inclined flaps without any opposing contrary force being exerted. This causes the inclined flaps to pivot downwards and maintains them in the lowered safety position. In this situation, the lower parts (39, 40, 51, 52) of the inclined flaps are impelled towards their counterparts, but without being in engagement with the rail.

As the connection (6), which joins the guidance head (2) to the vehicle, exerts force on the guidance head (2), pressing it towards the guide rail, the guidance head (2) will be automatically pushed downwards and will descend once more towards the guide rail (23).

Because the inclined flaps (35, 36, 49, 50) of the side components (33, 34) are in the lowered safety position, the distance existing between the lower parts (39) and (40), or between the lower parts (51, 52) and their counterparts on the other side component, is insufficient for the head (24) of the guide rail (23) to be able to pass between the inclined flaps during the descent of the guidance head (2).

The lower part (39, 40, 51, 52) of the inclined flaps (35, 36, 49, 50) is thus in abutment against the rail head (24) and, more specifically, against the inclined rolling tracks (27, 28) of the guide rail (23), as shown in FIGS. 13, 14 and 27, 28.

The head of the guide rail—more specifically its inclined rolling tracks (27, 28) in the example illustrated—then exerts a reaction force on the lower part (39, 40, 51, 52) of the inclined flaps (35, 36, 49, 50) that opposes the downward return force of the guidance head (2). This upwardly-directed reaction force constitutes an upwardly-directed re-engagement force of which the strength is equal to that of the return force exerted by the guidance head.

By design, the inclined flaps (35, 36, 49, 50) and, where appropriate, their resilient thrust system (67, 68) have been sized so that the sum of their vertical downward return component exerted on the inclined flaps remains lesser than the downward return force of the guidance head (2); this sum is also less than the re-engagement force exerted in response by the rail head.

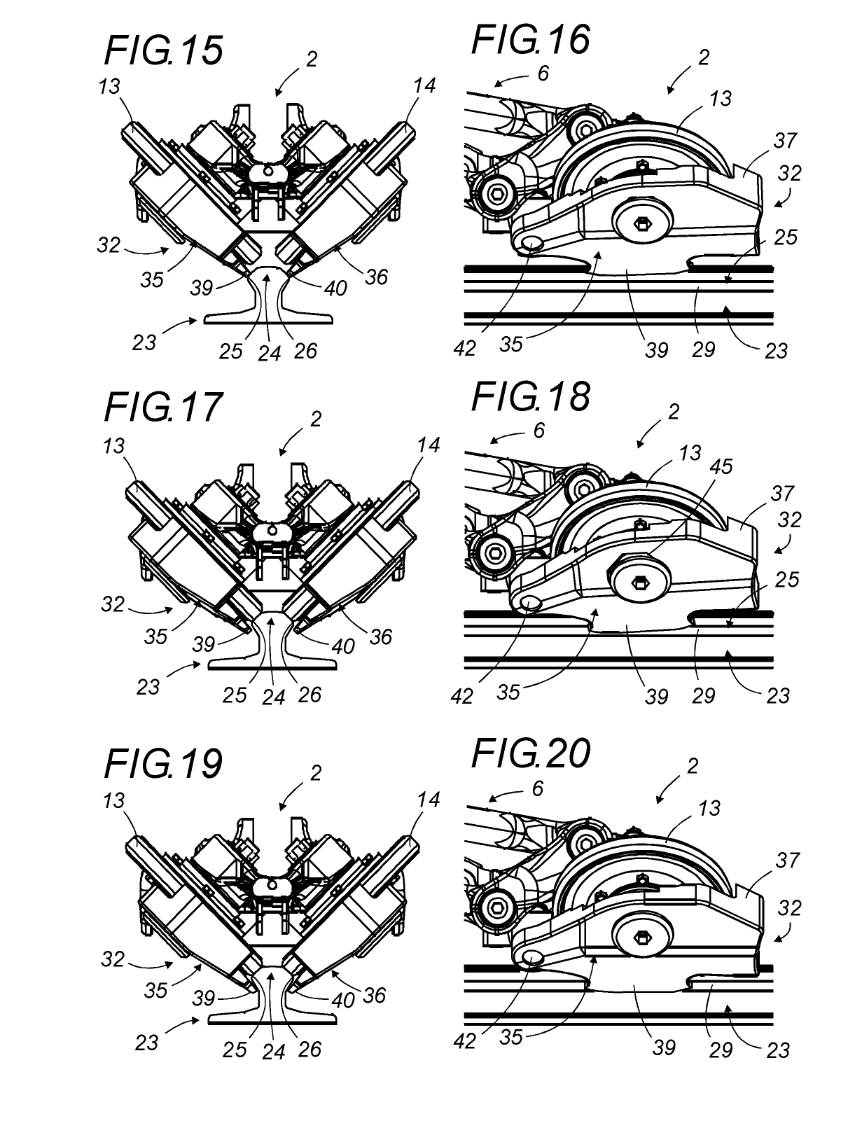

This re-engagement force counteracts the downward return force exerted continuously on the inclined flaps (35, 36, 49, 50) and pushes the lower part (39, 40, 51, 52) of these flaps upwards. Thus, it causes the inclined flaps (35, 36, 49, 50) to pivot upwards progressively as the guidance head (2) descends, as shown in FIGS. 15, 16, 29, 30, until they reach their raised re-engagement position, as shown in FIGS. 17, 18, 29, 30.

The flaps open because their pivot axes are inclined. If the axes were horizontal, the flaps would not separate, even if the flaps were inclined.

Due to this upward pivoting of the flaps (35, 36, 49, 50), and because of the inclination of their axes of rotation, the lower parts (39, 40, 51, 52) of each side component (33, 34) progressively separate from their opposite counterparts until they are in the raised re-engagement position, and are sufficiently distanced to allow the head (24) of the guide rail to pass between them.

Although it is not essential, especially for a guidance system with vertical rollers, the presence of the head (24) of the guide rail (23) of the inclined tracks (27) and (28) is advantageous, because these inclined tracks (27, 28) play a role as ramps that facilitate the pivoting movement of the flaps, while rendering it progressive.

When inclined flaps (35, 36, 49, 50) are in the raised re-engagement position, the head (24) of the guide rail can pass between the side components (33, 34) of the anti-extraction safety system (32), and the guidance head (2) can continue its downward movement until the guide roller(s) (13, 14) is/are once more in contact with its/their respective rolling track (27, 28) on the head (24) of the guide rail (23).

As soon as the lower part (39, 40, 51, 52) of the inclined flaps (35, 36, 49, 50) has passed beyond the protruding sides (24, 26) of the guide rail (23), the upwardly-directed reaction force exerted on the inclined components disappears.

In the absence of an upward re-engagement force, nothing else opposes the downward return force exerted continually on the inclined flaps. This return force generated by the weight of the inclined flaps, and/or by the thrust springs (69, 70), causes the downward pivoting of the inclined flaps until they are in the lowered safety position, with their bottom part (39, 40, 51, 52) extending under the protruding sides (25, 26) of the guide rail (23), as shown in FIGS. 19, 20, 31, 32.

Re-engagement is then complete. The guidance system (1) is again in a normal guidance situation, as described above, and the anti-extraction safety system (32) according to the invention—of which the inclined flaps (35, 36, 49, 50) are held in the lowered safety position—once more fulfills the desired anti-extraction safety function.

It is restated here that the return spring of the flaps or of each flap can be replaced by an actuator with commanded opening or closure. This variant can be useful if one wants to deliberately command disengagement from the guide rail.

Obviously, the invention is not limited to the preferred implementations described above and illustrated in the various figures. An appropriately-knowledgeable professional could make many modifications and devise other variants, without departing from the scope of the invention as specified by the appended claims.

1. A guidance head of a guidance system for a road vehicle with at least one guide roller designed to roll on the upper surface of the head of a guide rail on the ground, with sides, each being connected by a recess in the body of the rail;
with at least one guide being mounted on a shaft on a mounting of the guidance system;
with the guidance system being joined to the vehicle by a connection that is distortable under the effect of movement of the guidance head when it is in engagement with the guide rail, and constraining the guidance head to remain in contact with the head of the guide rail;
with this guidance head being equipped with an anti-extraction safety system, and being characterized in that:
the anti-extraction safety system incorporates, on each side, a side component that does not rotate with the at least one guide roller, of which the base is designed to be located, in use, under the corresponding recess in the guide rail, to counteract a force that would cause extraction of the guidance system;
at least one of its side components incorporates at least one flap inclined downwards towards the guide rail, with the said at least one flap being pivotally articulated about an inclined pivot axis such that the at least one flap pivots between:
a lowered safety position in which the lower part of the at least one flap extends, in use, under the corresponding recess of the guide rail, so as to oppose extraction of the guidance system; and
a raised re-engagement position in which the lower part of the at least one flap is, in use, laterally distanced from the corresponding side of the guide rail, allowing its vertical passage relative to the guide rail and, therefore, the disengagement or re-engagement of the guidance system from or onto the guide rail;
the at least one flap is subjected to a downward force which keeps it in the lowered safety position, but which allows the pivoting of the at least one flap into the raised re-engagement position when an upwardly-directed force exceeding the downward force is applied to the lower part of the at least one flap or when this pivoting is commanded by an actuator.

2. The guidance head according to claim 1, characterized in that the inclined pivot axis of the at least one flap is inclined upwardly towards the guide rail and, when this flap is in the lowered safety position, is located above the lower part of the flap.

3. The guidance head according to claim 1, characterized in that the inclined pivot axis of the at least one flap is located to the rear of the at least one flap relative to the direction of travel of the vehicle.

4. The guidance head according to claim 1, characterized in that the downward force applied to the at least one inclined flap is a simple gravity-driven return caused by the own weight of the at least one inclined flap or is augmented by an additional resilient downward return force.

5. The guidance head according to claim 4, characterized in that the at least one side component also incorporates a thrust spring, or some other resilient means of thrust that exerts additional resilient downward return force.

6. The guidance head according to claim 1, characterized in that the at least one inclined flap is a substantially flat plate of generally rectangular, triangular or hexagonal form, with a front corner that is truncated or untruncated.

7. The guidance head according to claim 1, characterized in that the at least one inclined flap has an enveloping shape that covers the bottom part of the at least one guide roller.

8. The guidance head according to claim 7, characterized in that the at least one inclined flap is extended by an enveloping bend, in the manner of a fairing.

9. The guidance head according to claim 1, characterized in that the front end, or the front end and the rear end, of the lower part of the at least one inclined flap is shaped into an ejection beak.

10. The guidance head according to claim 1, characterized in that the at least one inclined flap has a cutout through which the shaft passes, by which the at least one guide roller is fitted onto the mounting, such that this shaft extends beyond the at least one inclined flap.

11. The guidance head according to claim 10, characterized in that the shaft also acts as a low travel limiter in the lowered safety position of the at least one inclined flap by bearing of the upper rim of the cutout, against the upper part of the shaft, and as a high travel limiter in the raised re-engagement position of the at least one inclined flap by bearing of the lower rim of the cutout against the lower part of the shaft.

12. The guidance head according to claim 1, characterized in that at least one of the side components incorporates a front flap and a rear flap, with these front and rear flaps each being independently and individually articulated to pivot around an inclined pivot axis, with each flap pivoting between:
a lowered safety position wherein the lower parts of the front and rear flaps extend, in use, under the corresponding recess in the guide rail, in a manner that opposes the extraction of the guidance system; and
a raised re-engagement position wherein the lower parts of the front and rear flaps are, in use, laterally distanced from the corresponding side of the guide rail, thereby allowing their vertical passage relative to the rail guide and the according release or re-engagement of the guidance system from or onto the guide rail; and with
these front and rear flaps being subjected to a downward force that maintains them in the lowered safety position, but that allows them to pivot to the raised re-engagement position when an upwardly-directed force greater than the downward force is applied to the lower part of the front flap and to the lower part of the rear flap, or when this pivoting is commanded by an actuator.

13. The guidance head according to claim 12, characterized in that the front flap and the rear flap are of generally triangular overall shape and are positioned extending from each other in opposing directions, so as to approximately reconstitute the form of a single flap.

14. The guidance head according to claim 12, characterized in that the inclined pivot axis of the front flap is located in the front part thereof, and by the fact that the inclined pivot axis of the rear flap is located in the rear part of the rear flap.

15. The guidance head according to claim 12, characterized in that the front and rear flaps each have a cutout which opens, in one case, onto the rear edge of the front flap and, in the other case, onto the front edge of the rear flap such that, when the front flap and rear flap are in the usage position, the said cutouts extend to be in opposition to each other, and are in correspondence with each other, thereby forming an opening through which the shaft passes, on which at least one guide roller is fitted on the mounting.

16. The guidance head according to claim 12, characterized in that the front end of the lower part of the front flap and the rear end of the lower part of the rear flap are formed into an ejection beak.

17. The guidance head according to claim 1, characterized in that each of the side components incorporates at least one flap inclined downwards towards the rail guide, with the at least one flap being pivotally articulated about an inclined pivot axis pivotable between:
a lowered safety position in which the lower part of the at least one flap extends, in use, under the corresponding recess of the guide rail, so as to oppose extraction of the guidance system; and
a raised re-engagement position in which the lower part of the at least one flap is, in use, laterally distanced from the corresponding wall of the guide rail, allowing its vertical passage relative to the guide rail and, accordingly, disengagement or re-engagement of the guidance system from or onto the guide rail and with
the at least one flap being subjected to a downward force that maintains the at least one flap in a lowered safety position, but which allows the pivoting of the at least one flap into the raised re-engagement position when an upwardly-directed force that exceeds this downward force is applied to the lower part of the at least one flap or when such pivoting is commanded by an actuator.
